(19) United States
(12) Patent Application Publication
(10) Pub. No.: US 2023/0279922 A1
(43) Pub. Date: Sep. 7, 2023

(54) BELTS FOR INHIBITING TOOTH JUMP IN PERSONAL MOBILITY AND INDUSTRIAL APPLICATIONS

(71) Applicant: THE GATES CORPORATION, Denver, CO (US)

(72) Inventors: Thomas S. MOSS, III, Englewood, CO (US); Kyle SPRING, Englewood, CO (US); Scott IRVING, Dumfries (GB); David LEWIS, Dumfries (GB)

(21) Appl. No.: 17/955,531

(22) Filed: Sep. 28, 2022

Related U.S. Application Data
(60) Provisional application No. 63/315,416, filed on Mar. 1, 2022.

(51) Int. Cl. F16G 1/28; F16G 1/08

(52) U.S. Cl. CPC F16G 1/28; F16G 1/08

(57) ABSTRACT

Endless belts, such as for use with e-bikes and other personal mobility systems such as standard bicycles, wheelchairs, scooters including electric scooters, and other systems that utilize a belt for transmitting power to impart motion to the system. The belts are particularly suited for inhibiting “tooth jumping” during use, having a curvature coefficient of no more than 0.01%, and in some embodiments less than 0.005%, with a compressibility coefficient of no more than 0.00075. The belts can utilize reinforcing cords, such as carbon cords, which when incorporated into the final belt, some cords have an open porosity of 10 vol-% or less, in some embodiments 5 vol-% or less.

### CROSS-REFERENCE TO RELATED APPLICATION(S)

The present application claims the benefit of priority to U.S. Provisional Patent Application No. 63/315,416, entitled “BELTS FOR INHIBITING TOOTH JUMP IN PERSONAL MOBILITY AND INDUSTRIAL APPLICATIONS”, filed on Mar. 1, 2022, the entirety of which is hereby incorporated by reference.

### BACKGROUND

Industrial belts, such as power transmission belts, generally work in concert with a gear or sprocket that engages the belt and moves the belt upon rotation of the gear or sprocket. One issue that may arise with respect to such systems is “tooth jump”. Tooth jump occurs when a tooth of the belt slips over a tooth of the gear or sprocket it is engaged with. Tooth jump may occur when the belt/teeth are not sufficiently rigid and durable when under a load. For example, an insufficiently rigid belt/tooth may stretch under load, which may lead to tooth jump. Accordingly, a need exists for belts having limited elongation (extension, or stretch) when under load while still exhibiting a relatively high modulus.

### SUMMARY

The present disclosure is directed to toothed belts, such as for use with e-bikes and other personal mobility systems such as standard bicycles, wheelchairs, scooters including electric scooters, and other industrial systems that utilize a belt for transmitting power to impart motion to the system. The toothed belts can also be used in systems that conventionally use a chain and a sprocket(s) or gears to transmit power in drive systems, including the mobility systems described above and also in industrial drive systems.

The belts of this disclosure are particularly suited for inhibiting “tooth jumping” during use, improving belt lifetime and overall system efficiency. The belts have a curvature coefficient of less than 0.01%, and preferably no more than 0.005%, with a compressibility coefficient of no more than 0.00075. In some embodiments, the belts utilize load carrying fiber cords, such as carbon cords, which when incorporated into the final belt, have an open porosity of 10 vol-% or less, in some embodiments 5 vol-% or less. Other embodiments are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is perspective view of a portion of a belt according to this disclosure.

FIG. 2 is a perspective view of a portion of another belt according to this disclosure.

FIG. 3 is a graphical representation of belt extension as a function of load.

FIG. 4 is another graphical representation of belt extension as a function of load.

FIG. 5 is a photomicrograph of a carbon cord.

FIG. 6 is a photomicrograph of another carbon cord.

### DETAILED DESCRIPTION

As described above, described herein are belts particularly suited for mobility purposes, belts that have an ability to avoid elongation (extension, or stretch) when under load.

In the following description, reference is made to the accompanying drawing that forms a part hereof and in which is shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

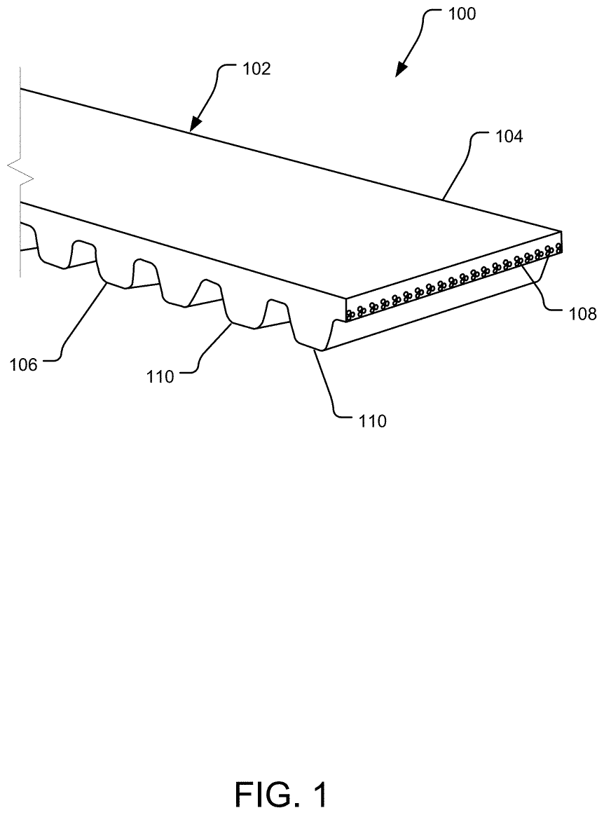

FIG. 1 shows a belt 100 according to this disclosure, the belt 100 being cut to show a cross-section thereof. The belt 100 has a body 102 formed of a flexible material (described below) having a back side 104 and a front side 106 with a plurality of load carrying cords 108 within the body 102, the particular cords 108 bound in triplicate bundles. The cords 108 may be, e.g., carbon cords, polymeric cords (e.g., polyester, aramid), fiberglass cords, etc. Defined in the front side 106 are a plurality of teeth 110; in this implementation, trapezoidal teeth are depicted in FIG. 1 but the tooth shape is not limited thereto and can take any shape that is compatible with a sprocket or gear. Each individual tooth 110 extends perpendicular to the longitudinal length of the belt 100, so that the plurality of teeth 110 run along or around the length of the belt 100. In use, the teeth 110 on the front side 106 are in contact with a drive mechanism, e.g., a toothed gear or sprocket. Although not seen in FIG. 1, the belt 100 is an endless belt, having the form of a loop with no beginning and no end.

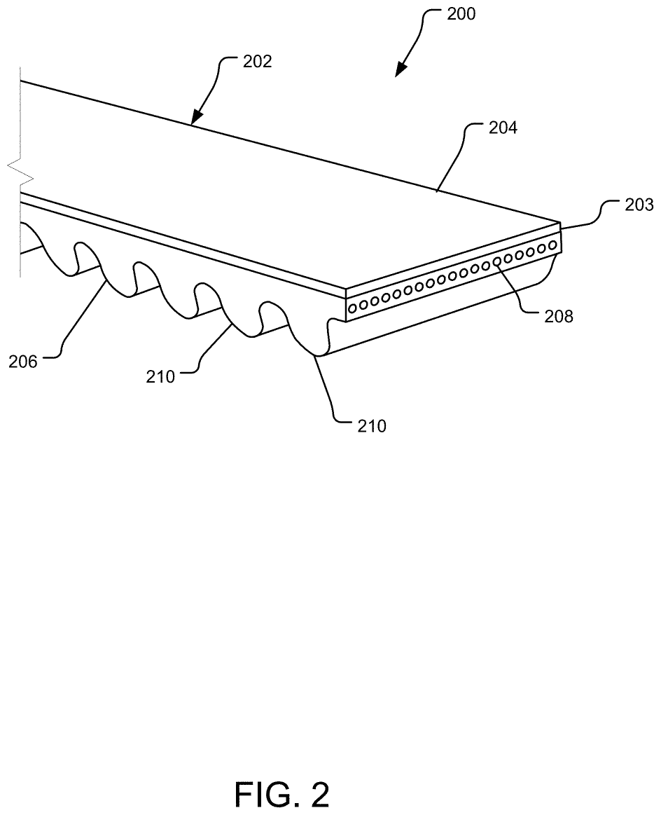

FIG. 2 shows another belt 200 according to this disclosure cut to show a cross-section thereof. The belt 200 has a body 202 formed of a flexible material having a back side 204 and a front side 206 with a plurality of cords 208 within the body 202. This belt 200 includes a backing 203 on the back side 204 of the belt; this backing 203 may be, e.g., a reinforcing mesh, such as nylon, at least partially embedded in or engulfed by the body 202. Defined in the front side 206 are a plurality of teeth 210, in this implementation, rounded teeth. Each individual tooth 210 extends perpendicular to the longitudinal length of the belt 200, so that the plurality of teeth 210 run along or around the length of the belt 200. In use, the teeth 210 on the front side 206 are in contact with a drive mechanism, e.g., a toothed gear or sprocket. Although not seen in FIG. 2, the belt 200 is an endless belt, having the form of a loop with no beginning and no end.

The belts 100, 200 are designed to avoid “tooth jump” during use, where a tooth 110, 210 jumps out of place or otherwise does not engage or mesh correctly with the drive mechanism. The belt should be sufficiently flexible and strong to transfer the power from the drive system. However, this should be balanced with the belt being sufficiently rigid and durable when under a load to inhibit “tooth jumping,” which happens when a toothed belt stretches under an applied load and slips or “jumps” in the gear. In addition to excessive stretching or elongation of a belt leading to tooth jump, excessive stretching or elongation also can decrease the efficiency and durability of the belt. The belts 100, 200 according to this disclosure have a limited elongation (extension, or stretch) when under load. Additionally, the belts have a high modulus but with a minimal curvature coefficient.

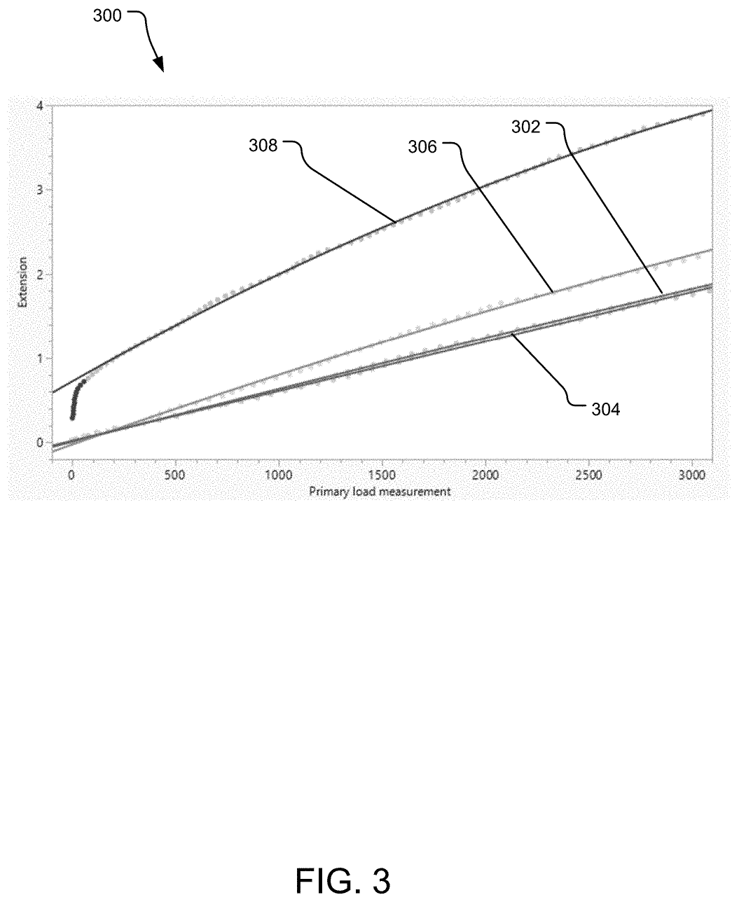

FIG. 3 provides a graphical representation 300 of belt extension as a function of applied load. Data for four different belts is shown in the graph 300, two of which are acceptable for inhibiting tooth jump. In FIG. 3, the graph 300 has a data line 302 for a first belt, a data line 304 for a second belt, a data line 306 for a third belt, and a data line 308 for a fourth belt. For the acceptable belts, the graph 300 shows a high modulus with a minimal amount of curvature to the data. In FIG. 3, if a vertical line is drawn at a specific load, one finds the elongation exhibited by each of the belt constructions.

The first belt (data line 302) was a cast polyurethane belt with carbon cord reinforcement, with the carbon cord composed of 21 intertwined strands or ends. The belt is commercially available from Gates Corporation under the tradename Poly Chain® CDX™ synchronous belt. This first belt had an acceptable amount of elongation under load to inhibit tooth jump, showing almost no curvature in the data and a high modulus, which is also a low compressibility.

The second belt (data line 304) was a cast polyurethane belt with carbon cord reinforcement, with the carbon cord composed of 19 intertwined strands or ends. This second belt had an acceptable amount of elongation under load to inhibit tooth jump, showing no curvature in the data and a high modulus, which is also a low compressibility.

The third belt (data line 306) was a cast polyurethane belt with carbon cord reinforcement, with the carbon cord composed of 18 intertwined strands or ends. This third belt had too much curvature in the data and is therefore susceptible to tooth jump.

The fourth belt (data line 308) was a cast polyurethane belt with carbon cord reinforcement, with the carbon cord composed of 21 intertwined strands or ends. The belt is commercially available from Gates Corporation under the tradename CDN™ Urban belt. This fourth belt had a curvature coefficient greater than 0.001%.

The data for the four belts summarized above (providing data lines 302, 304, 306, 308) are summarized in the following Table 1.

TABLE 1

| | Intercept | Linear | Quadratic | curvature | |
|---|---|---|---|---|---|
| Belt | (b^{Adj}1) | (a₁) | (a₂) | coefficient | Fit R² |
| 302 | 0.02708 | 0.000608 | −1.04e−8 | 0.00171% | 99.9% |
| 304 | 0.02175 | 0.000588 | 0 | 0% | 99.9% |
| 306 | 0.04249 | 0.000764 | −3.85e−8 | 0.00504% | 99.8% |
| 308 | 0.9167 | 0.001090 | −1.11e−7 | 0.0102% | 99.9% |

The amount of curvature, or curvature coefficient, is defined as the ratio of the quadratic coefficient (a₂) from the fit to the linear portion (a₁) (i.e., a₂/a₁), based on a fit of the data in this form: y=(b₁)+(a₁)x+(a₂)x². Compressibility, or compressibility coefficient, is the linear portion (a₁) of the curve, shown in Table 1.

As seen from Table 1, belts having a curvature coefficient of less than 0.01% and preferably no more than 0.005% inhibit or prevent tooth jump. Belts having a curvature coefficient of no more than 0.004% also inhibit or prevent tooth jump, as well as belts having a curvature coefficient of no more than 0.003% and no more than 0.002%. Additionally or alternately, belts having a compressibility coefficient of no more than 0.00075 inhibit or prevent tooth jump, as well as belts having a compressibility coefficient of no more than 0.0006 or 0.0005.

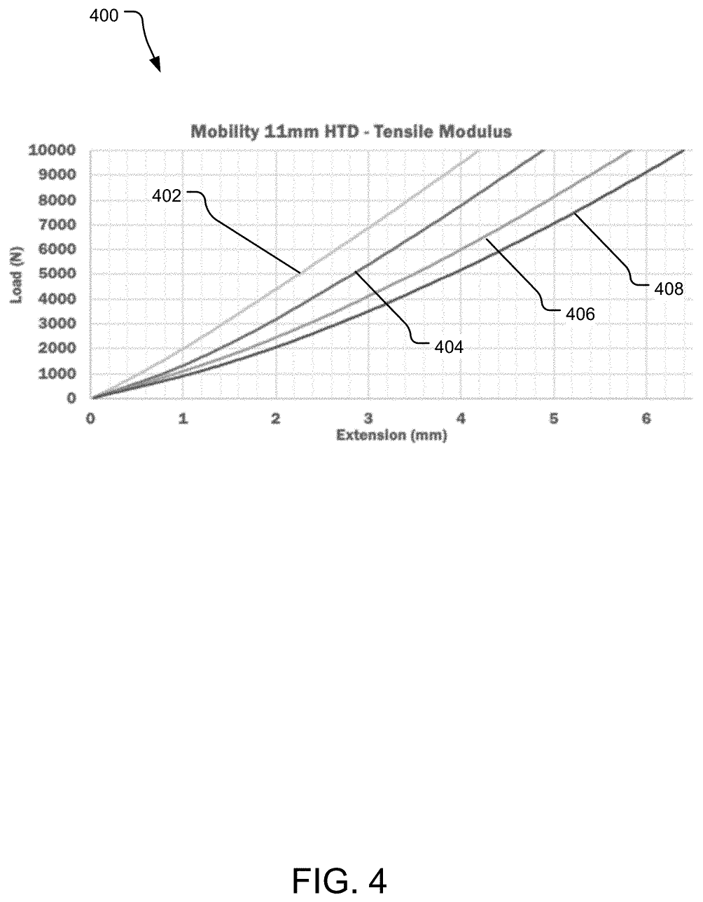

FIG. 4 provides a different graphical representation 400 of belt extension as a function of applied load. It is noted that the axes in FIG. 4 are switched in comparison to the graph 300 of FIG. 3.

Data for four different belts is shown in the graph 400. In FIG. 4, the graph 400 compares belts as described herein versus belts of different composition but of the same thickness, length and number of teeth. The graph 400 has a data line 402 for a first belt, a data line 404 for a second belt, a data line 406 for a third belt, and a data line 408 for a fourth belt.

The first belt (data line 402) was a cast polyurethane belt with carbon cord reinforcement. The belt is commercially available from Gates Corporation under the tradename Poly Chain® CDX™ synchronous belt. This first belt had a suitable amount of elongation under load to inhibit tooth jump.

The second belt (data line 404) was a cast urethane belt with carbon cord reinforcement, the carbon cord having approximately 0 vol-% open porosity. This second belt had an acceptable amount of elongation under load to inhibit tooth jump.

The third belt (data line 406) was a cast urethane belt with carbon cord reinforcement, the carbon cord having approximately 34 vol-% open porosity. This third belt did not have an acceptable amount of elongation under load (i.e., it had too much elongation) and therefore exhibited tooth jump.

The fourth belt (data line 408) was a cast polyurethane belt with carbon cord reinforcement. The belt is commercially available from Gates Corporation under the tradename CDN™ Urban belt. This fourth belt is susceptible to tooth jump.

The graph 400 illustrates the improved performance of belts as described herein having a carbon cord with 10 vol-% or less porosity as compared to previously known belts and belts having greater than 10 vol-% porosity. From this graph, it was determined that belts (e.g., rubber belts) having load carrying carbon cord that has no more than 10% open porosity have an amount of elongation under load that inhibits tooth jump. Belts that have load carrying carbon cord that has no more than 5% open porosity also have an amount of elongation under load that inhibits tooth jump.

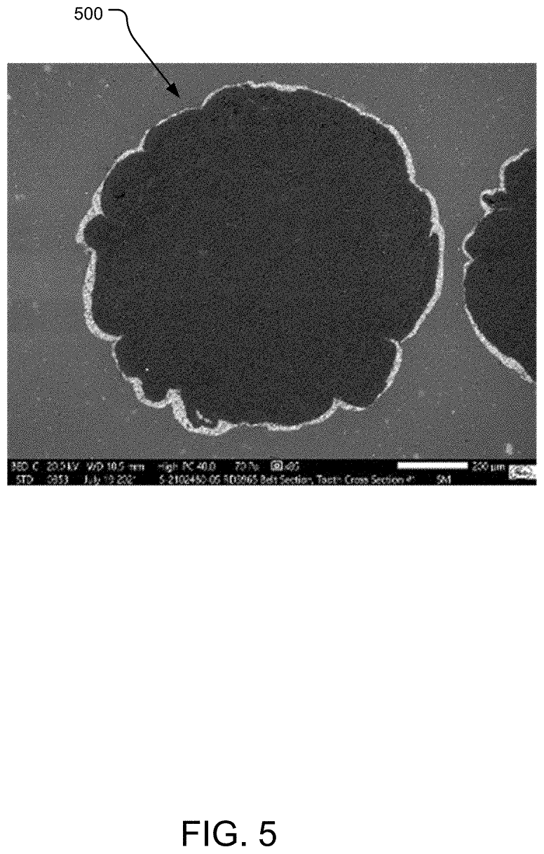

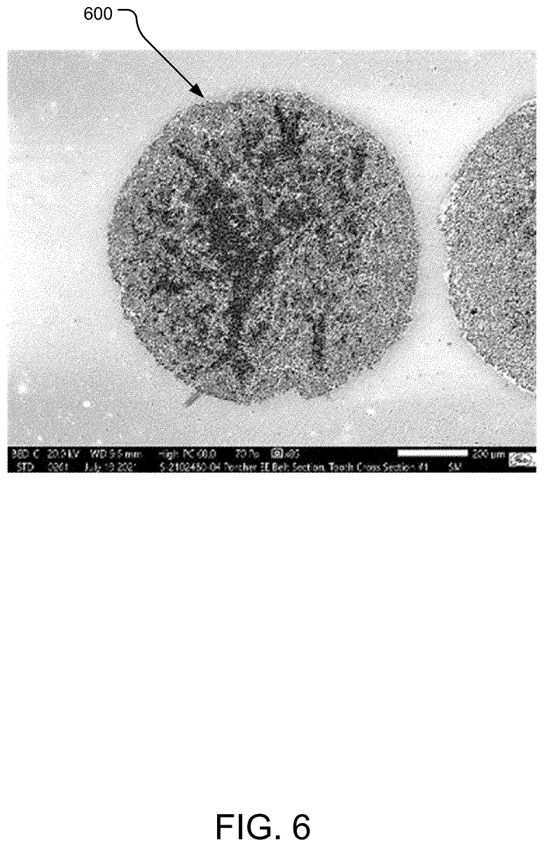

FIGS. 5 and 6 show examples of a carbon cord that has 10 vol-% or less open porosity and a carbon cord with more than 10 vol-% open porosity, respectively.

FIG. 5 shows a cross-section of a carbon cord 500 having a 1.01 mm diameter that is formed by a plurality of individual carbon fibers or strands, also referred to as “ends”. The cord 500 is essentially 100 vol-% solid or filled, with essentially 0 vol-% porosity.

FIG. 6 shows a cross-section of a carbon cord 600 having a 0.90 mm diameter that is formed by a plurality of aligned individual carbon fibers. The cord 600 is about 66.8 vol-% solid or filled, with about 33.2 vol-% porosity. A belt such as the belt 100 or the belt 200 with the cord 600 can exhibit tooth jump as it would have a larger amount of elongation under load.

Belts 100, 200 can be made by any suitable method. One suitable method includes mixing together raw ingredients to form a mixture; forming the mixture into a sheet; molding the sheet to form a cylinder and curing the cylinder; removing the cured cylinder from the mold and cutting the cylinder into a plurality of individual belts; and, optionally, grinding and/or profiling the belt to its final dimensions, as necessary.

Another suitable method includes mixing together raw ingredients to form the body; milling or extruding the mixture to form a sheet; calendering the sheet; bannering together several sheets of the calendered sheet; slab building a belt on a toothed mold using at least the bannered sheet; curing the belt structure in the mold to form a cylinder; removing the cured cylinder from the mold and cutting the cylinder into a plurality of individual belts; and, optionally, grinding and/or profiling the belt to its final dimensions, as necessary.

The raw ingredients, whether solid (e.g., particulate) or liquid, are mixed together to form a mixture; the ingredients may be combined sequentially, simultaneously, or in any combination thereof. The raw ingredients mixed together generally include base elastomer or rubber stock, reinforcement material, filler material, binder (e.g., oil), and curing agent(s). Other adjuvants such as plasticizers, antidegradants (e.g., UV stabilizers), antistatic agents, colorants, processing aids, coagents, and the like may also optionally be added.

In some embodiments, the mixing is generally carried out using an industrial mixer, such as a Banbury mixer, to mix together all raw ingredients; however, other mixing techniques and methods can be used. In some embodiments, the individual raw ingredients are added into the mixer in a specific sequence to ensure sufficient incorporation and dispersion of the raw ingredients. In some embodiments, certain raw ingredients can be mixed together prior to being added in sequence into the mix.

With respect to the rubber stock, any suitable rubber stock can be used. In some embodiments, the rubber stock is in the form of a powder, pellet, bale or block. Exemplary suitable rubber stock includes, but is not limited to, natural rubber, styrene-butadiene rubber (SBR), chloroprene rubber (CR), ethylene elastomers (EE), ethylene propylene elastomers (e.g., EPDM and EPM) and other ethylene-elastomer copolymers such as ethylene butene (EBM), ethylene pentene and ethylene octene (EOM), nitrile butadiene rubber (NBR), hydrogenated nitrile butadiene rubber (HNBR), polyurethane elastomer (PU), chlorinated polyethylenes (CPE), and fluoroelastomers (FKM). The rubber stock may be a mixture of two or more of these materials, in varying ratios. In some embodiments, the amount of rubber stock used is from 30 wt-% to 70 wt-% of the total weight of the raw ingredients. In some embodiments, the rubber stock is from about 40 wt-% to 60 wt-% of the total weight of the raw ingredients.

The belts include cords as the load carrying cord extending along the length of the belts. Details regarding inclusion of the cords in the belts are described below. The load carrying cord can be carbon cord. In other embodiments, the load carrying cord can comprise metal, ceramic, fiberglass, polybenzoxazole (PBO), aramid, nylon, polyester (PET), and any combinations thereof.

In some embodiments, an additional reinforcement material (additional to the carbon cords) may be present in the belt, for example, distributed throughout the rubber body. Some embodiments use fiber or filament segments or nanotubes as the reinforcement material, though other reinforcement material, such as elongated segments, can also be used. The reinforcement material may be any of, e.g., aramid, polyester (PET), cotton, nylon, glass, carbon, metal, ceramic, thermoplastic, or hybrid. The reinforcement material may be made from either organic or synthetic material, or a mixture of organic and synthetic materials.

The dimensions of the reinforcement material are generally not limited. In some embodiments, chopped fibers of reinforcement material have a high aspect ratio having a length in the range of from 0.2 mm to 3 mm. In some embodiments, the reinforcement materials (e.g., chopped fibers) have an aspect ratio of from 10 to 250. In some embodiments, the amount of reinforcement material is from 5 wt-% to 30 wt-% of the total weight of the raw ingredients forming the body. In some embodiments, the reinforcement material is from about 6 wt-% to about 14 wt-% of the total weight of the raw ingredients. The reinforcement material is mixed with the raw ingredients and the resulting belt has the reinforcement materials homogeneously dispersed throughout. The reinforcement material is different than the elongate carbon cords (e.g., carbon cords 108, 208).

In some embodiments of the belts described herein, a filler material such as carbon black may be used, though other filler(s) can be used, either alone or in conjunction with carbon black. Other suitable fillers include, but are not limited to clay(s), pulp(s) and silica(s). In some embodiments, the amount of filler is from 5 wt-% to 45 wt-% of the total weight of the raw ingredients that form the body. In some embodiments, the filler is from about 10 wt-% to about 20 wt-% of the total weight of the raw ingredients.

U.S. Pat. Nos. 5,610,217 and 6,616,558 provide additional information regarding material formulations and mixing methods for forming a mixture to be used in forming a belt, some or all of which may be used in forming the belts described herein. U.S. Pat. Nos. 5,610,217 and 6,616,558 are therefore incorporated herein by reference in their entirety.

The various dimensions of the belt described herein (e.g., thickness, diameter, etc.) are generally not limited, and may vary based on the specific application for the belt.

The above specification and examples provide a complete description of the structure and use of exemplary embodiments of the invention. The above description provides specific embodiments. It is to be understood that other embodiments are contemplated and may be made without departing from the scope or spirit of the present disclosure. The above detailed description, therefore, is not to be taken in a limiting sense. For example, elements or features of one example, embodiment or implementation may be applied to any other example, embodiment or implementation described herein to the extent such contents do not conflict. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

1. An endless belt, comprising:
a belt having a front surface and a back surface, the belt having a body, with a plurality of load carrying cords within the body, the belt having a curvature coefficient of no more than 0.005% and a compressibility coefficient of no more than 0.00075.

2. The belt of claim 1 comprising a plurality of teeth formed on the front surface.

3. The belt of claim 1, wherein the load carrying cords are carbon cords.

4. The belt of claim 1, wherein the load carrying cords having an open porosity of 10 vol-% or less.

5. The belt of claim 4, wherein the load carrying cords having an open porosity of no more than 5 vol-%.

6. The belt of claim 1, wherein the curvature coefficient is no more than 0.004%.

7. The belt of claim 6, wherein the curvature coefficient is no more than 0.003%.

8. The belt of claim 7, wherein the curvature coefficient is no more than 0.002%.

9. The belt of claim 1, wherein the compressibility coefficient is no more than 0.0006.

10. The belt of claim 1, wherein the body is a rubber body.

11. The belt of claim 10, wherein the rubber body comprises consisting of natural rubber, styrene-butadiene rubber (SBR), chloroprene rubber (CR), ethylene propylene diene monomer rubber (EPDM), hydrogenated nitrile butadiene rubber (HNBR), ethylene elastomer copolymers, fluoroelastomers, and combinations thereof.

12. The belt of claim 1, wherein the body is a polyurethane body.

13. The belt of claim 1, further comprising a filler selected from the group consisting of carbon black, clays, pulps, silicas, and combinations thereof.

14. The belt of claim 1, further comprising a reinforcing mesh proximate the back surface.

15. An endless belt, comprising:
a belt having a front surface and a back surface, the belt having a body, with a plurality of load carrying cords within the body, the belt having a curvature coefficient of no more than 0.005% and the load carrying cords having an open porosity of 10 vol-% or less.

16. The belt of claim 15, wherein the load carrying cords having an open porosity of no more than 5 vol-%.

17. The belt of claim 15, wherein the curvature coefficient is no more than 0.002%.

18. An endless belt, comprising:
a belt having a front surface and a back surface, the belt having a body, with a plurality of load carrying cords within the body, the belt having a compressibility coefficient of no more than 0.00075 and the load carrying cords having an open porosity of 10 vol-% or less.

19. The belt of claim 18, wherein the load carrying cords having an open porosity of no more than 5 vol-%.

20. The belt of claim 18, wherein the compressibility coefficient is no more than 0.0006.
